(19) United States
(12) Patent Application Publication
(10) Pub. No.: US 2023/0409493 A1
(43) Pub. Date: Dec. 21, 2023

(54) REDUCING PERFORMANCE DEGRADATION FROM NEGLIGENT OR MALICIOUS DEVICE ATTACKS

(71) Applicant: Intel Corporation, Santa Clara, CA (US)

(72) Inventors: Rupin Vakharwala, Hillsboro, OR (US); Garrett Drown, Chandler, AZ (US)

(21) Appl. No.: 17/836,468

(22) Filed: Jun. 9, 2022

(51) Int. Cl. G06F 12/14; G06F 12/02

(52) U.S. Cl. CPC G06F 12/1491; G06F 12/1433; G06F 2212/7201; G06F 12/0292; G06F 12/0246

(57) ABSTRACT

Embodiments described herein may include apparatus, systems, techniques, or processes that are directed to optimizing memory access and minimizing performance degradation due to faulty or malicious devices attempting to access improper memory locations. Faulty/malicious devices' memory accesses are quickly blocked reducing performance degradation due to the avoidance of costly memory lookups and fault generation/processing. Other embodiments may be described and/or claimed.

### TECHNICAL FIELD

Embodiments of the present disclosure generally relate to the field of computing, in particular, to memory access control.

### BACKGROUND

An input/output memory management unit (IOMMU) is a memory management unit (MMU) that connects a direct memory access (DMA) capable input/output (I/O) bus to the main memory of a computing system. Like a traditional MMU, which translates central processing (CPU)-visible virtual addresses to physical addresses, the IOMMU maps device-visible virtual addresses (also called device addresses or I/O addresses) to physical addresses. Both traditional MMUs and IOMMUs use one or more mapping tables to translate the virtual addresses to physical addresses. The mapping tables may be stored locally, in system memory or in other locations in the computing system. In computing systems that use virtualization, guest operating systems may use hardware that is not specifically made for virtualization and the IOMMU handles the address translation or mapping, allowing the native device drivers to be used in a guest operating system.

Some MMU units also provide memory protection from faulty or malicious devices. For example, an IOMMU may protect memory from malicious devices that attempt DMA attacks and/or faulty devices that attempt incorrect memory accesses (accessing memory that has not been explicitly allocated or mapped for it).

As scalability, security, virtualization, and the like continue to become more important to computing systems, the IOMMU design and features become a prominent and critical component in the IO-domain. One of the services the IOMMU provides is to isolate one device from another device. One device should not be able to severely impact the performance of another device. However, a malicious device can easily issue DMA operations to memory it is not allowed to access—this may also be referred in some instances as a Denial-of-Service attack. The IOMMU blocks such malicious DMA operations but in the process may consume a significant amount of IOMMU hardware resources and bandwidth. As such, valuable resources available for non-malicious devices is reduced, significantly reducing performance, and violating the desired isolation services.

A solution is needed that reduces the IOMMU performance impact from improper memory access operations.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a diagram showing an example of a computer system in accordance with various embodiments.

FIG. 2 is an illustration of a page walk control flow sequence according to some embodiments.

FIG. 3 is an illustration of a mapping table entry according to some embodiments.

FIG. 4 is a memory translation operation according to various embodiments.

FIG. 5 is a page walk operation according to various embodiments.

FIG. 6 is a software operation to determine actions taken upon a memory transaction rejection according to various embodiments.

FIG. 7 is a block diagram of a system in accordance with another embodiment such as a data center platform.

FIG. 8 illustrates a block diagram of an example processor that may have more than one core and an integrated memory controller.

### DETAILED DESCRIPTION

Embodiments described herein may include apparatus, systems, techniques, and/or processes that are directed to memory access control. Embodiments described herein enable quick and efficient identification of bad transactions from certain devices and/or processes and reject such transactions, consuming as few IOMMU resources as possible. According to embodiments of the invention, a blocking identifier is provided in one or more mapping tables.

Such blocking identifier may include one or more bits set in a table entry corresponding to a device. When a memory access request is received, an IOMMU will look for the address translation in a IOMMU translation cache (also referred to as an IOMMU translation lookaside buffer (TLB)). If the translation is available and the blocking identifier is not set to block, the IOMMU processes the translation and allows the memory transaction to proceed. If the translation is available and the blocking identifier is set to block, the memory access operation is aborted/rejected. If the translation is not found in the IOMMU translation cache, a page miss occurs. To resolve the page miss, a page walk occurs where the physical address is resolved by accessing one or more mapping tables in memory. An IOMMU will terminate the page walk if it encounters a set blocking identifier. This occurrence may be stored in the IOMMU translation cache enabling all subsequent faulty or malicious memory access operations from the device to be quickly identified and aborted with minimal resource consumption and allowing non-malicious devices to get their share of IOMMU resources and performance According to some embodiments, IOMMU mapping tables are in memory and the IOMMU translation cache (aka IOMMU TLB) stores information that is a combination from multiple levels of these tables in a more compact representation. Overall system performance degradation is avoided due to the blocked transactions being quickly and efficiently aborted.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

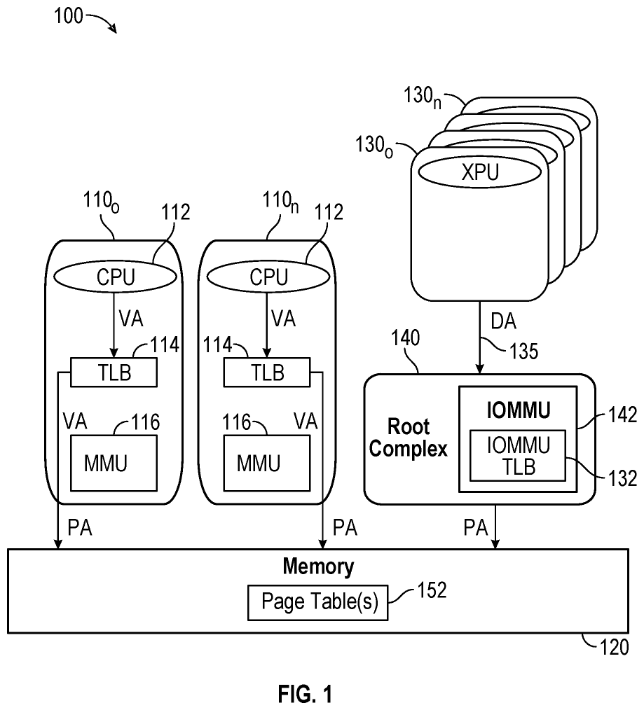

FIG. 1 is a diagram showing a computer system in accordance with various embodiments. A computer system 100 may be any type of computing platform, ranging from small portable devices such as smartphones, tablet computers and so forth to larger devices such as client systems, e.g., desktop systems or workstations, server systems and so forth. As shown, system 100 includes a plurality of CPUs 110₀-110ₙ. CPUs 110 communicate with a memory 120 that is further shared with a set of devices XPUs 130₀-130ₙ. Although shown generically in FIG. 1 as XPUs, understand that many different types of devices such as various peripheral component interconnect express (PCIe) devices, any offload or accelerator device, Virtual Machines (VMs), processes operating on one or more components, or other such devices may be present in a given system. As further shown, a root complex 140 provides an interface between memory 120 and XPUs 130.

As illustrated in the high level of FIG. 1, CPUs 110 may include a processor complex (generally CPU 112) which may include one or more cores or other processing engines. As seen, software that executes on these processing units may output virtual addresses (VAs) that may be provided to a translation lookaside buffer (TLB) 114. In general, TLBs 114 may buffer virtual-to-physical addresses and potentially additional information. Such cache capability may be on behalf of a memory management unit (MMU) 116, which may include a greater set of address translations by way of a multi-level page table structure. In addition, MMU 116 may further include page miss handling circuitry to obtain address translations, e.g., from memory 120 when not present.

Similarly, root complex 140 includes another MMU, namely an IOMMU 142, that may store address translations on behalf of XPUs 130 in an IOMMU TLB 132. Thus, as shown, requests for translation may be received in root complex 140 from given XPUs 130 and in turn IOMMU 142 processes a physical address. Such translations may be stored in a TLB within XPU 130, not shown. Then, with this physical address a memory request (e.g., read or write) to memory 120 may proceed. Note that in different implementations, root complex 140 may be a separate component or can be present in an SoC with a given one or more CPUs. In alternate embodiments, IOMMU TLB 132 may be implemented as coupled to IOMMU 142 as part of root complex 140.

In different embodiments, an interconnect 135 that couples XPUs 130 to root complex 140 may provide communication according to one or more communication protocols such as PCIe, Compute Express Link (CXL) (such as a CXL.io protocol) or an integrated on-chip scalable fabric (IOSF), as examples. One or more XPUs 130 may be integrated onto a same SOC die as a CPU, integrated onto a different die but in the same package or may be a separate peripheral device. In one embodiment, one or more XPUs 130 may be integrated with IOMMU 142, for example, on the same die or in the same package.

Using entries located in IOMMU TLB 132 configured by an operating system (OS) and/or Virtual Machines (VMs) and Virtual Machine Monitors (VMMs), memory management units (MMUs) translate virtual addresses (VAs) into physical addresses (PAs) for CPUs, and IOMMUs translate device or virtual addresses (DAs or VAs) into physical addresses for devices as shown in FIG. 1. If an address translation is not found in a IOMMU TLB 132, a page walk occurs and the address translation is determined using one or more page table(s) 152. Page tables 152 and IOMMU TLB 132 may be configured by the OS, a VMM or other software services. The address translation is terminated if a set blocking identifier associated with the requesting device is encountered, whether in the IOMMU TLB 132 or in the one or more page table(s) 152.

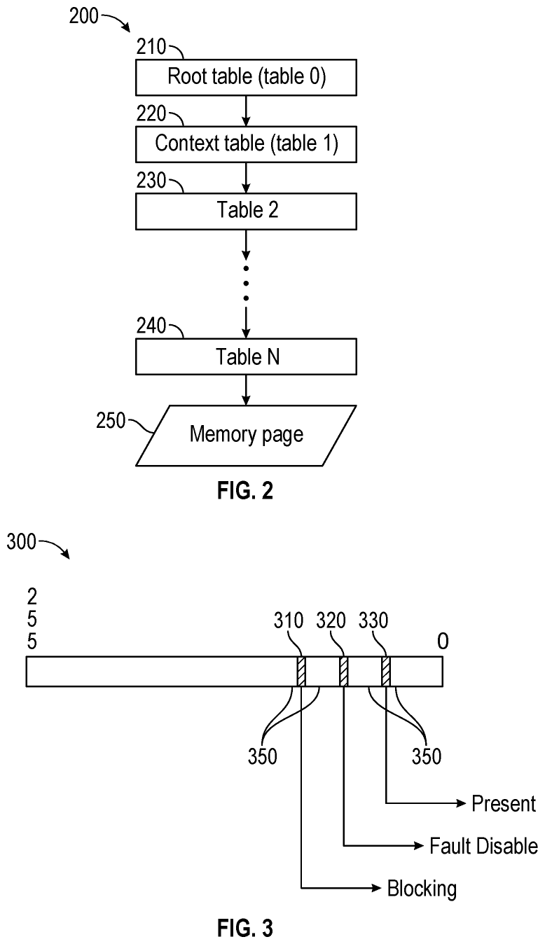

FIG. 2 is an illustration of a page walk control flow sequence according to some embodiments of the invention. Page walk 200, also referred to as a table walk, shows a series of tables used in address translation. Table walk 200 begins by accessing a Root Table 210, also referred to as Table 0. Root table 210 functions as the top level structure to map devices to the respective domains, i.e., physical memory addresses. The location of the root-table in memory is implementation dependent and may be stored in an IOMMU TLB, for example. Entries in root table 210 contain device and/or process identifiers and pointers to the corresponding information in Context table 220, also referred to as Table 1. Entries in context table 220 further map the devices and processes, and in turn, to the address translation structure used to generate a physical memory address. Tables 230 (also referred to as Table 2) through 240 (also referred to as Table N) are accessed using device and/or process identifiers and pointers to the next table until the full physical address for memory page 250 is generated. In some embodiments, memory page 250 is 4 KB in size. One of the tables may include a process address space identifier (PASID) directory. Setting a blocking identifier may identify a single PASID or multiple PASIDs. For example, PASIDs 0-63 or 64-127 may be blocked using a single blocking identifier according to various embodiments.

In an alternate embodiment, a PASID directory is stored locally, for example on or coupled to an IOMMU, and a directory look up occurs in parallel with the address translation/remapping. This look up may occur before, during and/or after the address translation/remapping according to various embodiments.

A page walk is time-consuming and resource intensive as it involves reading the contents of multiple memory locations and using them to compute a physical address. After the physical address is determined by the page walk, the virtual address to physical address mapping is entered into the IOMMU TLB. By incorporating a blocking identifier in a mapping table entry, a bad memory transaction may be quickly rejected, reducing the bandwidth and time impact on the overall system.

FIG. 3 is an illustration of a mapping table entry according to some embodiments. Mapping table entry 300 may be located, for example, in IOMMU TLB 132 and/or page table(s) 152 of FIG. 1, and/or any other mapping tables located in a computer system. As illustrated, mapping table entry 300 may be 256 bits wide. Blocking information 310 may be 1 or more bits wide. Fault disable information 320 indicates whether faults are to be generated and processed when an error occurs and may be 1 or more bits wide. Present information 330 indicate whether the translation table entry is present (i.e., if the memory location is mapped and assigned to a device or function/process) and may be 1 or more bits wide. When present information 330 is set to indicate not present, most other fields in table entry 300 are ignored. In some embodiments, the specific device or process ID information is not included in the page-table entry since the entry belonging to a specific device or process is found using a suitable index into the various tables. Remaining information 350 may contain other translation information such as pointers to other tables, security information, addressing information, device information and the like. Information 350 may also include bits reserved for future use which are typically set to a single value, for example, 0. The exact location of the bits in table entry 300 are implementation specific and may vary across table entries and/or mapping tables according to different embodiments. Fault disable information 320 and/or present information 330 may not be implemented in some embodiments. Information 310-350 may be configured by the OS, VMM, or other software service.

When bad memory transactions, for example, attempts to access improper memory locations, are first encountered, software, for example, OS or VMM software, will determine if blocking is needed, and, if so, set table entry 300 to indicate blocking is active for the identified device or process. If blocking information 310 is set to indicate blocking is active, when encountered, address translation is stopped and the memory transaction is rejected. Software may also determine whether to disable fault reporting and processing by setting fault disable information 320 accordingly.

When determining whether and how to set one or more blocking identifiers 310, software services may use heuristic type algorithms to identify malicious or faulty devices. Some examples of characteristics that may be monitored are the overall number of faults generated, the frequency of fault generated, the causing device or process and the like. Software services may determine to block an entire device or one or more processes from a given device.

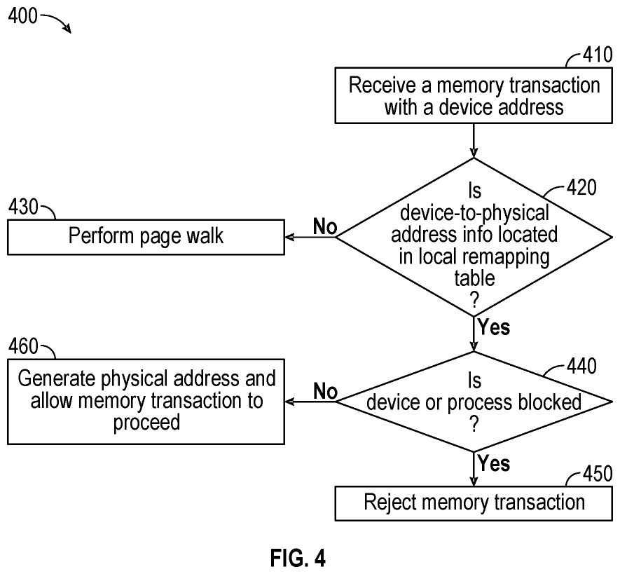

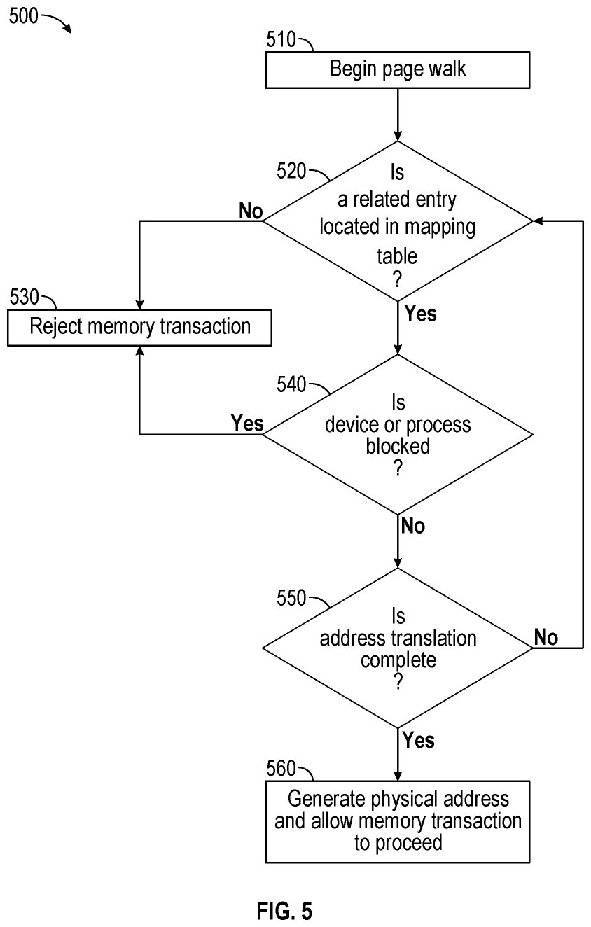

FIG. 4 is a memory translation operation 400 according to various embodiments. Operation 400 begins when a memory transaction is received requiring memory translation of a device address to a physical address, block 410. The IOMMU TLB or other local translation cache(s) is read to determine if there is a table entry for the transaction, for example, by checking the present information bit(s) in the entry, block 420. Such table entry may contain information relevant to the device-to-physical address translation. In some embodiments, a device-to-physical translation is achieved using data stored in the IOMMU TLB that is information combined from multiple levels of translation caches in a compact form. If translation information is not present in the IOMMU TLB, a page walk is performed, at block 430—see also FIG. 5. If translation information is present, a determination is made if the transaction by device or process is blocked, for example, by checking the blocking information bit(s) in the entry, block 440. If the transaction is blocked, the transaction is rejected, block 450. When this occurs, an error message may be sent to the requesting device or process and a fault may or may not be generated as dictated by the fault disabling information, if such information is included according to some embodiments. If the transaction is not blocked, the physical address is processed and generated and the memory transaction is allowed to proceed, block 460.

FIG. 5 is a page walk operation 500 according to various embodiments. Page walks may be performed by the IOMMU 142 hardware to IO transactions. Operation 500 begins with the identification that a page walk is necessary, block 510. A first mapping table, for example, Root table 210 as illustrated in FIG. 2, is read to determine if there is a corresponding table entry, block 520, for example, using present information located in the table entry. If there is not a corresponding entry, the memory translation is discontinued and the memory transaction is rejected, block 530, similar to block 450 of FIG. 4. If the translation is present, a determination is made if the transaction by device or process is blocked, for example, by checking the blocking information bit(s) in the entry, block 540. If the transaction is blocked, the transaction is rejected, block 530. If the transaction is not blocked, the information in the entry is processed and a determination is made whether the address translation is complete, block 550. If the address translation is not complete, pointer(s) to the next table are used to access the next table, returning to block 520. If the address translation is complete, the physical address is processed and generated and the memory transaction is allowed to proceed, block 560.

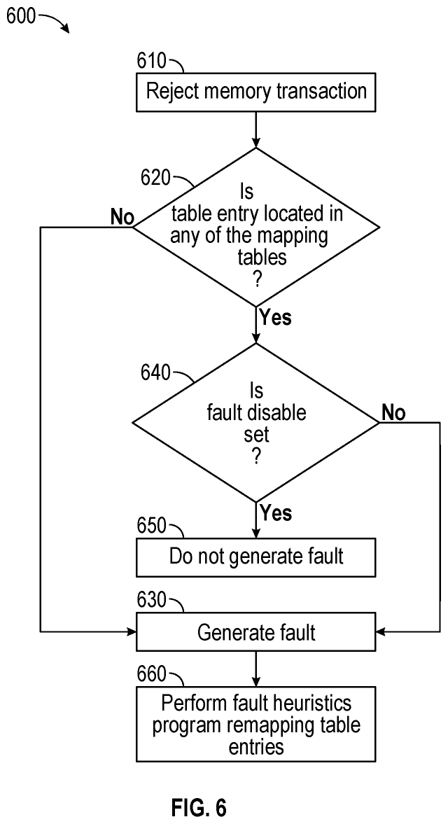

FIG. 6 is a software operation 600 to determine actions taken upon a memory transaction rejection according to various embodiments. Process 600 occurs upon recognition of a memory transaction to be rejected, block 610, for example, also corresponding to block 450 of FIG. 4 and block 530 of FIG. 5. A determination is made whether a table entry corresponding to the requesting device or process was located in any other mapping tables, block 620. If not, a fault is generated, block 630. If a corresponding table entry is present, a determination is made whether the fault disable identifier is set, block 640. If not, a fault is generated, block 630. If the fault disable identifier is set, i.e., disabling faults, a fault is not generated, block 650. Once a fault is generated, software services may perform fault heuristics and program mapping table entries, including blocking identifiers and fault disable bit(s) accordingly, block 660.

Detailed below are descriptions of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

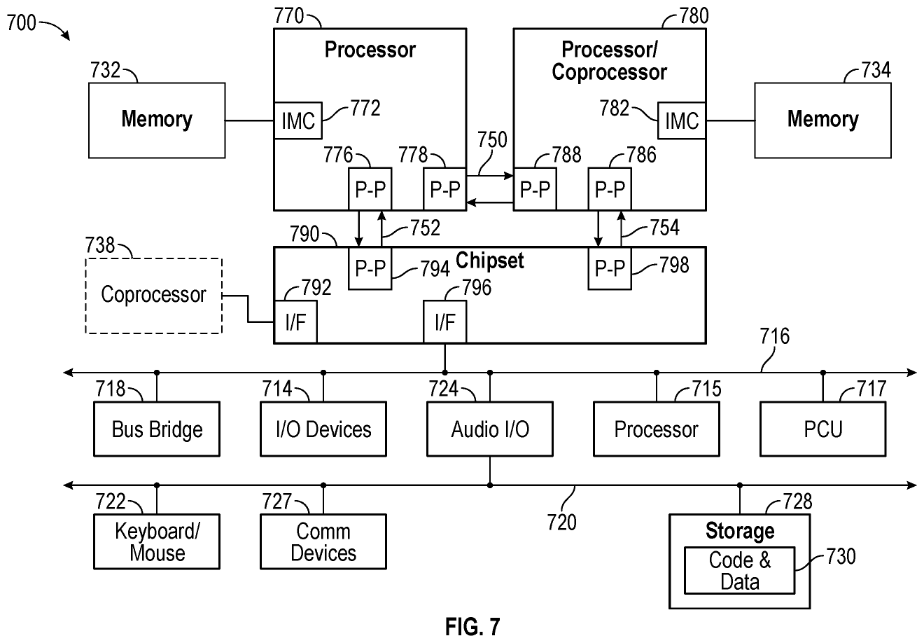

FIG. 7 illustrates a block diagram of a system in accordance with another embodiment. Multiprocessor system 700 is a point-to-point interconnect system and includes a plurality of processors including a first processor 770 and a second processor 780 coupled via a point-to-point interconnect 750. In some examples, the first processor 770 and the second processor 780 are homogeneous. In some examples, first processor 770 and the second processor 780 are heterogenous. Though the system 700 is shown to have two processors, the system may have three or more processors, or may be a single processor system. Processors 770 and 780 are shown including integrated memory controller (IMC) circuitry 772 and 782, respectively. Processor 770 also includes as part of its interconnect controller point-to-point (P-P) interfaces 776 and 778; similarly, second processor 780 includes P-P interfaces 786 and 788. Processors 770, 780 may exchange information via the point-to-point (P-P) interconnect 750 using P-P interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a chipset 790 via individual P-P interconnects 752, 754 using point to point interface circuits 776, 794, 786, 798. Chipset 790 may optionally exchange information with a coprocessor 738 via an interface 792. Chipset 790 may be implemented on one or more dies, for example, having a memory controller circuit and IO control on separate dies or even separate packages. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, a data streaming accelerator, an in-memory data analytics accelerator, XPU as described herein, or the like.

A shared cache (not shown) may be included in either processor 770, 780 or outside of both processors, yet connected with the processors via P-P interconnect, such that either or both processors' local cache information may be stored in the shared cache if a processor is placed into a low power mode.

Chipset 790 may be coupled to a first interconnect 716 via an interface 796. In some examples, first interconnect 716 may be a Peripheral Component Interconnect (PCI) interconnect, or an interconnect such as a PCI Express interconnect or another I/O interconnect. In some examples, one of the interconnects couples to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interconnect 716, along with a bus bridge 718 which couples first interconnect 716 to a second interconnect 720. In some examples, one or more additional processor(s) 715, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 716. In some examples, second interconnect 720 may be a low pin count (LPC) interconnect. Various devices may be coupled to second interconnect 720 including, for example, a keyboard and/or mouse 722, communication devices 727 and a storage circuitry 728. Storage circuitry 728 may be one or more non-transitory machine-readable storage media as described below, such as a disk drive or other mass storage device which may include instructions/code and data 730. Further, an audio I/O 724 may be coupled to second interconnect 720. Note that other architectures than the point-to-point architecture described above are possible. For example, instead of the point-to-point architecture, a system such as multiprocessor system 700 may implement a multi-drop interconnect or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

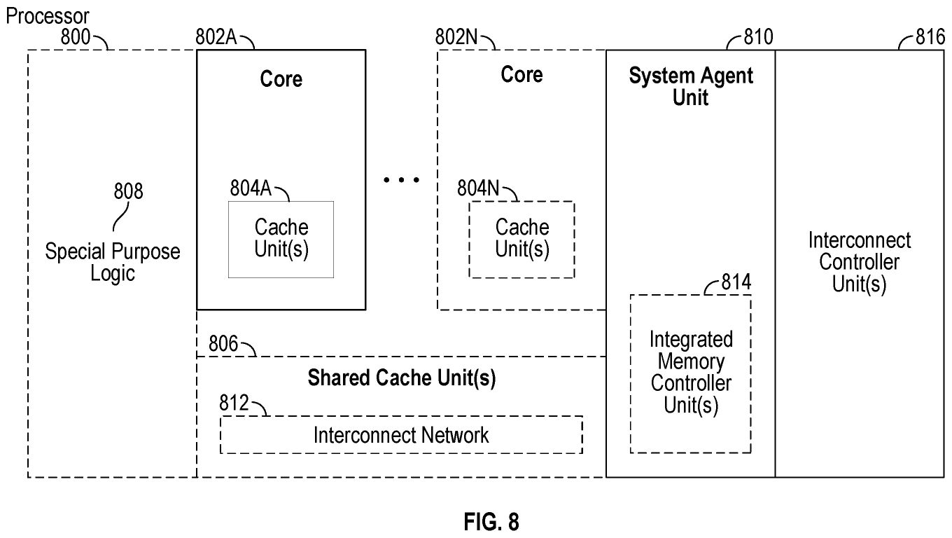

FIG. 8 illustrates a block diagram of an example processor 800 that may have more than one core and an integrated memory controller. The solid lined boxes illustrate a processor 800 with a single core 802A, a system agent unit circuitry 810, a set of one or more interconnect controller unit(s) circuitry 816, while the optional addition of the dashed lined boxes illustrates an alternative processor 800 with multiple cores 802(A)-(N), a set of one or more integrated memory controller unit(s) circuitry 814 in the system agent unit circuitry 810, and special purpose logic 808, as well as a set of one or more interconnect controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802(A)-(N) being one or more general purpose cores (e.g., general purpose in-order cores, general purpose out-of-order cores, or a combination of the two); 2) a coprocessor with the cores 802(A)-(N) being a large number of special purpose cores intended primarily for graphics and/or scientific (throughput); and 3) a coprocessor with the cores 802(A)-(N) being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples ring-based interconnect network circuitry 812 interconnects the special purpose logic 808 (e.g., integrated graphics logic), the set of shared cache unit(s) circuitry 806, and the system agent unit circuitry 810, alternative examples use any number of well-known techniques for interconnecting such units. In some examples, coherency is maintained between one or more of the shared cache unit(s) circuitry 806 and cores 902(A)-(N).

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

### EXAMPLES

The following examples pertain to further embodiments.

An example may be an apparatus, comprising a memory mapping table containing a table entry used to remap a device address to a physical address, the table entry associated with a requesting device of a memory transaction, the table entry comprising a blocking identifier corresponding to the requesting device indicating whether the memory transaction from the requesting device is to be rejected.

In another example, an apparatus includes an IO memory management unit (IOMMU), the IOMMU to receive a memory transaction request to access a system memory from a requesting device, the memory transaction request including a device address; the IOMMU to process the memory transaction request including to perform a translation of the device address to a physical memory address of the system memory; wherein to process the memory transaction request the IOMMU to access an address mapping table, the address mapping table containing a table entry corresponding to the requesting device; the table entry comprising: a blocking identifier corresponding to the requesting device indicating whether the memory transaction from the requesting device is to be rejected.

In another example, a software service is configured to monitor generated faults corresponding to the requesting device to determine a configuration of the blocking identifier in the table entry corresponding to the requesting device.

In another example, the table entry further comprising a fault disable bit that indicates whether to generate a fault if the memory transaction from the requesting device is to be rejected.

In another example, the requesting device is a group of processes and the blocking information indicates whether all memory transactions from the group of processes are to be rejected.

In another example, the table entry further comprises a present indicator to indicate that the table entry is valid.

In another example, the table entry further comprises a pointer to another mapping table.

In another example, the memory mapping table is stored in a system memory.

In another example, the IOMMU and the requesting device are on the same die.

In another example, the memory mapping table is a translation cache stored in a root complex coupled to the requesting device and a system memory.

In another example, the requesting device is a PCIe device.

In yet another a method comprises receiving a memory transaction from an entity, the memory transaction including a device address; accessing a memory mapping table to remap the device address to a physical address; identifying a table entry in the memory mapping table corresponding to the entity, the table entry comprising a blocking identifier; and determining if the memory transaction from the entity is to be rejected, the determining comprising evaluating the blocking identifier in the table entry.

In another example the method further comprises determining if a fault is to be generated if the memory transaction is to be rejected, the determining comprising evaluating a fault disable bit located in the table entry corresponding to the entity.

In another example, the method further comprises monitoring any faults generated to determine a configuration of the blocking identifier in the table entry corresponding to the entity.

In another example, the entity is a group of processes and the blocking identifier indicates whether all memory transactions from the group of processes are to be rejected.

In another example, the method further comprises evaluating a present indicator in the table entry to determine if the table entry is valid.

In another example, the table entry further comprises a pointer to another mapping table, the method further comprising accessing the another mapping table.

In yet another example, a computer-readable storage medium including computer-readable instructions, when executed, to implement a method as described in any one of the examples herein.

In yet another example an apparatus comprises means to perform a method as describe in any one the examples herein.

In yet another example, a system comprises a memory; an entity to request a memory transaction, the memory transaction including a device address; and an IO memory management unit (IOMMU) coupled to the system memory and the entity; the IOMMU to assist in the translation of the device address to a physical memory address of the memory; an address mapping table coupled to the IOMMU, the address mapping table containing a table entry corresponding to the entity; the table entry comprising blocking information corresponding to the entity indicating whether the memory transaction from the entity is to be rejected.

In another example, the table entry further comprises a fault disable bit that indicates whether to generate a fault if the memory transaction is rejected.

In another example, the entity is a group of processes and the blocking information indicates whether all memory transactions from the group of processes are to be rejected.

In another example, the table entry further comprising a present indicator to indicate that the table entry is valid.

In another example, the memory mapping table is stored in a system memory.

In yet another example, an apparatus comprises means for receiving a memory transaction from an entity, the memory transaction including a device address; means for accessing a memory mapping table to remap the device address to a physical address; means for identifying a table entry in the memory mapping table corresponding to the entity, the table entry comprising a blocking identifier; and means for determining if the memory transaction from the entity is to be rejected, the determining comprising evaluating the blocking identifier in the table entry.

In another example, the apparatus further comprises means for determining if a fault is to be generated if the memory transaction is to be rejected, the means for determining comprising means for evaluating a fault disable bit located in the table entry corresponding to the entity.

In another example, the apparatus further comprises means for monitoring any faults generated to determine a configuration of the blocking identifier in the table entry corresponding to the entity.

In another example, the entity is a group of processes and the blocking identifier indicates whether all memory transactions from the group of processes are to be rejected.

In another example, the apparatus further comprises means for evaluating a present indicator in the table entry to determine if the table entry is valid.

In another example, the table entry further comprises a pointer to another mapping table, the apparatus further comprising means for accessing the another mapping table.

Another example may include an apparatus comprising means to perform one or more elements of a method described in or related to any of examples herein, or any other method or process described herein.

Another example may include one or more non-transitory computer-readable media comprising instructions to cause an electronic device, upon execution of the instructions by one or more processors of the electronic device, to perform one or more elements of a method described in or related to any of examples herein, or any other method or process described herein.

Another example may include an apparatus comprising logic, modules, or circuitry to perform one or more elements of a method described in or related to any of examples herein, or any other method or process described herein.

Another example may include a method, technique, or process as described in or related to any of examples herein, or portions or parts thereof.

Another example may include an apparatus comprising: one or more processors and one or more computer readable media comprising instructions that, when executed by the one or more processors, cause the one or more processors to perform the method, techniques, or process as described in or related to any of examples herein, or portions thereof.

Another example may include a signal as described in or related to any of examples herein, or portions or parts thereof.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
an IO memory management unit (IOMMU), the IOMMU to receive a memory transaction request to access a system memory from a requesting device, the memory transaction request including a device address; the IOMMU to process the memory transaction request including to perform a translation of the device address to a physical memory address of the system memory;
wherein to process the memory transaction request the IOMMU to access an address mapping table, the address mapping table containing a table entry corresponding to the requesting device; the table entry comprising:
a blocking identifier corresponding to the requesting device indicating whether the memory transaction from the requesting device is to be rejected.

2. The apparatus of claim 1, wherein the IOMMU further to monitor generated faults corresponding to the requesting device to determine a configuration of the blocking identifier in the table entry corresponding to the requesting device.

3. The apparatus of claim 1, the table entry further comprising a fault disable bit that indicates whether to generate a fault if the memory transaction from the requesting device is to be rejected.

4. The apparatus of claim 1, wherein the blocking identifier to indicate whether all memory transactions from a group of processes associated with the requesting device are to be rejected.

5. The apparatus of claim 1, the table entry further comprising a present indicator to indicate that the table entry is valid.

6. The apparatus of claim 1, the table entry further comprising a pointer to another mapping table.

7. The apparatus of claim 1, wherein the IOMMU and the requesting device are on the same die.

8. The apparatus of claim 1, wherein the address mapping table is a translation cache stored in a root complex coupled to the system memory.

9. The apparatus of claim 1, wherein the requesting device is a PCIe device.

10. A method comprising:
receiving a memory transaction from a requesting device, the memory transaction including a device address;
accessing a memory mapping table to remap the device address to a physical address;
identifying a table entry in the memory mapping table corresponding to the requesting device, the table entry comprising a blocking identifier; and
rejecting the memory transaction from the requesting device if the blocking identifier in the table entry indicates the memory transaction is to be rejected.

11. The method of claim 10, the table entry further comprising a fault disable bit, the method further comprising generating a fault if the memory transaction is to be rejected and the fault disable bit indicates to generate faults when rejecting the memory transaction.

12. The method of claim 11, further comprising monitoring any faults generated to determine a configuration of the blocking identifier in the table entry corresponding to the requesting device.

13. The method of claim 10, wherein the blocking identifier to indicate whether all memory transactions from a group of processes associated with the requesting device are to be rejected.

14. The method of claim 10, further comprising evaluating a present indicator in the table entry to determine if the table entry is valid.

15. The method of claim 10, the table entry further comprising a pointer to another mapping table, the method further comprising accessing the another mapping table.

16. A system comprising:
a system memory;
an entity to request a memory transaction, the memory transaction including a device address; and
an IO memory management unit (IOMMU) coupled to the system memory and the entity; the IOMMU to receive the memory transaction request; the IOMMU to process the memory transaction request including to perform a translation of the device address to a physical memory address of the system memory;
wherein to process the memory transaction request, the IOMMU to access an address mapping table, the address mapping table containing a table entry corresponding to the entity; the table entry comprising:
blocking information corresponding to the entity indicating whether the memory transaction from the entity is to be rejected.

17. The system of claim 16, the table entry further comprising a fault disable bit that indicates whether to generate a fault if the memory transaction is rejected.

18. The system of claim 16, wherein the blocking identifier to indicate whether all memory transactions from a group of processes associated with the entity are to be rejected.

19. The system of claim 16, the table entry further comprising a present indicator to indicate that the table entry is valid.

20. The system of claim 16, wherein the IOMMU and the requesting device are on the same die.
